(19) United States
(12) Patent Application Publication
(10) Pub. No.: US 2014/0333768 A1
(43) Pub. Date: Nov. 13, 2014

(54) METHOD FOR INTERACTIVE CONTROL OF A COMPUTER APPLICATION

(71) Applicants: Christopher Forster, Stuttgart (DE); Andreas Examitzki, Stuttgart (DE)

(72) Inventors: Christopher Forster, Stuttgart (DE); Andreas Examitzki, Stuttgart (DE)

(73) Assignee: ALCATEL LUCENT, Paris (FR)

(21) Appl. No.: 14/364,930

(22) PCT Filed: Dec. 13, 2011
(86) PCT No.: PCT/IB2011/003255

§ 371 Date: Jun. 12, 2014

(51) Int. Cl. H04N 7/18; G06F 3/01

(52) U.S. Cl. CPC H04N 7/183; G06F 3/017
USPC 348/143

(57) ABSTRACT

The present invention relates to a system, a method and a related device for controlling an interactive computer application, where the system comprises an application executing part that is adapted to execute the interactive computer application. The system of the present invention the system further comprises a sensoring part that is adapted to detect at least one of presence and movements of a person in a capture area of the sensoring part. The application executing part further is able to switch the application from an idle mode into a passive/control discovery application mode at first detection of a person in the capture area of the sensoring part and in that the application executing part additionally is adapted to switch the application from the passive discovery mode into an interaction mode if the presence of the person is detected for a predefined period of time; and in that the application executing part is adapted to interpret movements of the person as control commands for/of the application if the application is in the interaction mode.

The present invention relates to method, a related system and related devices for interactive control of a computer application.

Such a method and a system for control of an interactive computer application where the interactive application running on a computer system is well known in the art. Such an interactive computer application initially runs in an idle state if no person gives an explicit start command, where the explicit start command for instance may be a button push at the computer system or a touch at the application interface of such interactive computer application.

A camera based interactive application systems could be combined with wall or floor projections. However, currently, they are only used for passive interactivity, meaning that if a pedestrian enters the capture area of the camera something happens which cannot be directly influenced by the person. It is mostly based on a kind of motion detection. Real interaction via camera demands the detection of natural and intuitive human gestures.

Such solution still requires the explicit starting of an application by any potential user pushing a button, although such potential user participant may even not be aware of existence of the interactive computer application and if aware will not be aware of what action is required to start.

Problem of this art is how to start controlling a computer application without explicit acknowledgment of a potential participant or user of the application to start the application as a potential user is not always aware of the existence of the computer application and its possibilities.

An objective of the present invention is to provide an application control method and system and related computing device of the above known type but wherein the control can be initiated in a more flexible and intuitive manner.

According to the present invention, this object is achieved by the system according to claim 1, the method according to claim 8, a related device as described in claim 9.

Indeed, according to the invention, this object is achieved due to the fact that by first detecting the presence of a person in the capture area of a presence and motion sensoring part, the interactive computer application is switched from an initial idle mode into a second passive control discovery application mode and subsequently, if the presence of this person still is detected during a certain predefined period of time, the application is switched from the second passive discovery mode into a third interaction mode wherein gestures and movements of the person whose presence is detected are interpreted and accepted as control commands of the interactive application, where the fact that a person stays during a certain predefined period of time within the capture area of the sensoring part is accepted as an interest for interacting with the application consequentially serving as a confirmation for interacting with the interactive computer application.

A further characteristic feature of the present invention is described in claim 2.

The sensoring part comprises a camera that is adapted to detect presence and movements of a person within the capture area of said camera.

A further characteristic feature of the present invention is described in claim 3.

The sensoring part (SP) comprises a depth camera to detect presence and movements of a person in said capture area of said camera. Such depth camera could be n infrared camera. Such depth camera based on infrared additionally is able to perform its functions in dark areas independent of incidence of light.

Still a further characteristic feature of the present invention is described in claim 4 and claim 10.

The interactive computer application is an interactive advertisement application and the system further may or may not comprise an interface being an advertisement billboard.

Still a further characteristic feature of the present invention is described in claim 5 and claim 11.

The interactive computer application is an interactive gaming application where the interactive application may comprise an interface being a gaming billboard. Alternatively the interface may be any display.

Another further characteristic feature of the present invention is described in claim 6 and claim 12.

The interactive computer application is an interactive multimedia rendering application where the interactive application may comprise an interface being a gaming billboard. Alternatively the interface may be any display.

Still a further characteristic feature of the present invention is described in claim 7 and claim 13.

The interactive computer applications being in said passive control discovery application mode after a first detection of a person in the capture area of the sensoring part displays said person on coupled display. The interactive application for instance may show an avatar of the player at a coupled display or billboard. Hence the detected person will see an introduction to real interactivity. At presentation of such avatar the person will be aware of some kind of influence or control on the shown content.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein:

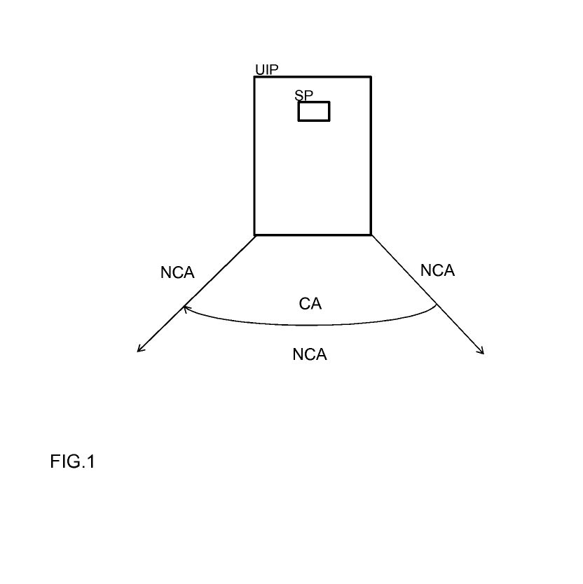

FIG. 1 represents an overview of the space wherein the present invention mobile device wherein the application switching method according the present invention is executed locally.

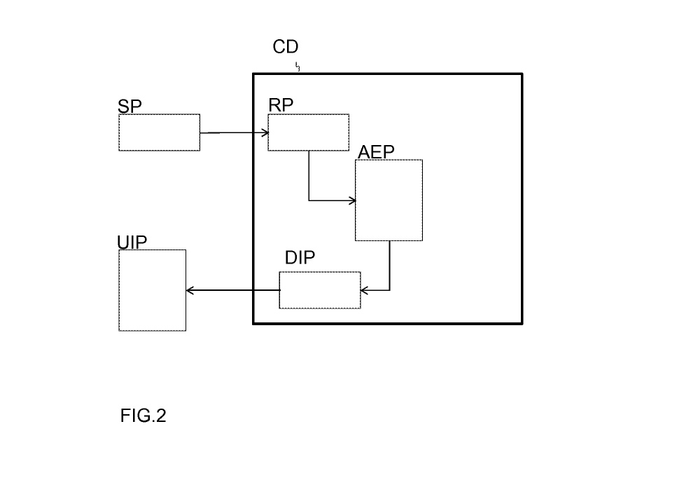

FIG. 2 represents a system including a computing device CD and a sensoring part wherein the controlling of an interactive computer application according to the present invention is executed.

In the following paragraphs, referring to the drawings, an implementation of the method for controlling an interactive computer application, a related system and related devices according to the present invention is described.

In the first paragraph of this description the main functional parts of the computing device CD as presented in FIG. 2 are described. In the second paragraph, all connections between the before mentioned elements and described parts are defined. In the succeeding paragraph the actual execution of the application switching method for session establishment is described.

First essential element of the present invention is a sensoring part SP that is adapted to detect at least one of presence and movements of a person in a capture area of the sensoring part SP. This sensoring part may be a commonly known camera or be a depth camera, like an infrared camera.

A characteristic of such sensoring part SP is that it has a certain capturing area, being the limited area wherein the sensoring part is able to detect presence of a person and movements of such person. This capturing angle is amongst others limited due to the angle of the camera lens. The capture area in FIG. 1 is denoted with CA and the area outside the capture area as INCA.

A further relevant element of the present invention is a computing device that first comprises an application executing part PP that is first is adapted to execute the interactive computer application. The application executing part PP further is adapted to switch the application from an idle mode into a passive control discovery application mode at first detection of a person in the capture area of the sensoring part SP, i.e. a camera. The application executing part PP additionally is adapted to switch the interactive application from the passive control discovery application mode into an interaction mode of the interactive computer application if the presence of the person is detected during a predefined period of time from the initial presence detection. The interactive computer application is able to, by means of the application executing part PP, to interpret movements of said person as control commands of the application only if the application is in the interaction mode. In case the interactive computer application is in idle mode the application does not offer any interactivity, but in case of a multimedia application, gaming application or advertisement application provides with a basic and standard presentation running repeating continuously.

In the subsequent case that the interactive computer application is in passive discovery mode the application does still not offer any interactivity, but in case of a multimedia application, gaming application or advertisement application provides with a basic and standard presentation inviting a person who is detected to participate in the interactive computer application, e.g. being the multimedia show, the game or the advertisement.

The computing device CD further comprises a Reception part that is adapted to receive a signal from the sensoring part where the signal is a signal including presence and/or movement information on a detected person being located within the capturing area. In case the sensoring part is a camera the signal are for instance the video signal recorded by the camera.

The computing device further comprises a Device interfacing part DIP that is adapted to interface with a user interfacing part UIP e.g. being a display or a billboard.

The user interfacing part UIP is the user interface of the system on which information of the interactive computer application is rendered e.g. being the multimedia rendering, the game rendering or the advertisement rendering.

The reception part RP of the computing device CD has an input-terminal that is at the same time an input terminal of the computing device CD. The reception part RP further is coupled to application execution part AEP that in turn further is coupled to the Device interfacing part DIP. The Device interfacing part DIP further has an output-terminal that is at the same time an output-terminal of the computing device CD.

In order to explain the execution of the present invention it is assumed that a certain pedestrian walks in direction of the system of the present invention, for controlling an interactive computer and a associated billboard application assuming the pedestrian is outside the capture area of the camera see FIG. 1. As in the current situation no person is detected by means of the camera, as the person still is located outside the capture area, the area being denoted with INCA, the interactive computer application is in idle mode and hence the application does not offer any interactivity. In case the interactive computer application is a multimedia application, gaming application or advertisement application, the interactive application provides with a basic and standard presentation running repeating continuously.

One possible scenario is an interactive gaming billboard. This billboard has three states which states differ in the kind of interactivity. In a state in which nobody is detected within the captured area of the camera a standard advertising loop is running on the billboard. If somebody appears in this area the camera will find, track and follow the person. Now the billboard will react in a passive manner to show the person that there is interactivity possible and he can be part of it.

Subsequently, the pedestrian approaches the billboard coupled to the system of the present invention and consequently enters the capture area CA of the coupled sensoring part i.e. the camera. The sensoring part detects the presence of the pedestrian in the capture area CA, i.e. the camera captures the presence of the pedestrian and sends the images via the receiving part RP of the computing device CD to the application executing part PP that subsequently switches the application from the idle mode into the passive control discovery application mode at the first detection of a person e.g. by detecting the face or the skeleton of the person, in the capture area of the sensoring part.

The interactive computer application, being in passive control discovery application mode, still does not offer any interactivity, apart from that the interactive application for instance may show an avatar of the player at a coupled display or billboard. Hence the detected person will see an introduction to real interactivity. At presentation of such avatar the person will be aware of some kind of influence or control on the shown content.

In case of a multimedia application, a gaming application or advertisement application provides with a basic and standard presentation inviting the pedestrian being in the capture area CA to participate in the interactive computer application, e.g. being the multimedia show, the game or the advertisement. In this passive state the avatar of the user is presented at the billboard and therefore there is a feedback of the interactivity for the tracked person. Currently he can move but there is not an interaction with the advertisement. In addition, the interactive application then may use dialogues like “hey you! Would you like to play?” are displayed to get more attention of the person in the capture area and to persuade him to participate in the application e.g. the multimedia application game or advertisement application. Such dialogues may be applied in order to let such person know that he as a person is part of the advertisement. The dialogue is direct communication which is more personal than a manual or a guideline.

In case the pedestrian subsequently is interested for some reason to interact with the application and stays within the capture area in the observed area, for a specific time period which is detected e.g. by finding the face or skeleton of the person back in a sequence of frames captured by the camera by means of the application executing part PP and switches the application from the passive control discovery application mode into the interaction mode if the presence of the person is detected for a predefined period of time; e.g. by finding the face of the person back in a sequence of frames captured by the camera.

After switching the interactive computer application into the interaction mode, the application executing part PP interprets movements of the person as control commands of the application.

In this interactive mode of the computer application, all movements of the user are captured, analyzed and subsequently interpreted as control signals of the application. In the interactive state the application e.g. a game will be introduced and starts automatically. Now the user can move and play, control the game with body movements. At the end of the game the result is visible together with a QR-Code as a give-away. When the user rests in the capture area the game will start again.

Now the person has control over the advertising. With this control a game could be played without any gadgets only by human gestures. In this example the gesture will be lateral body movements.

A camera recognizes people paying attention to the advertising solution. As remarkable feature frontal faces are used since interested persons face the application directly.

A camera recognizes people paying attention to the advertising solution. As remarkable feature also skeletons of people are used to guarantee a stable system independent of incidence of light and in interactive mode it allows interaction without frontal faces.

When a person is detected he is focused and tracked until this person leaves the observed area, i.e. the capture area where after the application switches back into the idle mode of the interactive application.

Focusing is done with a time based state machine to generate reliable results.

Tracking results like position and size changes can be used by the advertising application to customize the displayed content.

If no person is detected during a specified period of time the system switches to the idle mode state.

In both candidate and locked state the algorithm changes to initial state if the result could not be detected again and an according timeout expires e.g. when the tracked user left the area.

Beside the gaming idea also an exploring mode could be an opportunity in which gestures like arm wipes can be used similar to the iPhone screen navigation to change between images or use virtual objects.

Also augmented reality or 3D effects are a realistic extension to any kind of advertising campaign for the interactive gaming billboard.

It is to be noted that the sensoring part of in the present invention could be implemented by any other device able to detect presence and motion of a person.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is merely made by way of example and not as a limitation on the scope of the invention, as defined in the appended claims.

1. System for controlling an interactive computer application, said system comprising an application executing part, for executing said interactive computer application said system further comprising:
a sensoring part, adapted to detect at least one of presence and movements of a person in a capture area of said sensoring part; and
said application executing part, further being adapted to switch said application from an idle mode into a passive control discovery application mode at first detection of a person in said capture area of said sensoring part; and in that said application executing part additionally is adapted to switch said application from said passive discovery mode into an interaction mode if said presence of said person is detected for a predefined period of time; and in that said application executing part is adapted to interpret movements of said person as control commands for/of said application if said application is in said interaction mode.

2. System for controlling an interactive computer application according to claim 1, wherein said sensoring part comprises a camera adapted to detect presence and movements of a person in said capture area of said camera.

3. System for controlling an interactive computer application according to claim 1, wherein said sensoring part comprises a depth camera to detect presence and movements of a person in said capture area of said camera.

4. System for controlling an interactive computer application according to claim 1, wherein said interactive computer application is an interactive advertisement application.

5. System for controlling an interactive computer application according to claim 1, wherein said interactive computer application is an interactive gaming application.

6. System for controlling an interactive computer application according to claim 1, wherein said interactive computer application is an interactive multimedia rendering application.

7. System for controlling an interactive computer application according to claim 1, wherein said interactive computer applications being in said passive control discovery application mode after first detection of a person in said capture area of said sensoring part displays said person on coupled display.

8. Method for controlling a computer application said computer application, said computer application being executed by an application executing part, said method comprising:
detecting presence of a person in a camera capture area of a sensor;
switching said application from an idle mode into a passive control discovery application mode at first detection of a person in said capture area of said censoring part; and
switching said application from said passive discovery mode into an interaction mode if said presence of said person is detected for a predefined period of time; and
interpreting detected movements of said person as control commands of said application if said application is in said interaction mode.

9. Computing Device, for use in a system according to claim 1, wherein said device comprises an application executing part, for executing said interactive computer application said device further comprising:
a sensoring reception part, adapted to receive at least one of presence and movements of a person in a capture area detected by said sensoring part; and
said application executing part, further being adapted to switch said application from an idle mode into a passive control discovery application mode at first detection of a person in said capture area of said sensoring part; and in that said application executing part additionally is adapted to switch said application from said passive discovery mode into an interaction mode if said presence of said person is detected for a predefined period of time; and in that said application executing part is adapted to interpret movements of said person as control commands for/of said application if said application is in said interaction mode.

10. Computing Device for controlling an interactive computer application according to claim 9, wherein said interactive computer application is an interactive advertisement application.

11. Computing Device for controlling an interactive computer application according to claim 9, wherein said interactive computer application is an interactive gaming application.

12. Computing Device for controlling an interactive computer application according to claim 9, wherein said interactive computer application is an interactive multimedia rendering application.

13. Computing Device for controlling an interactive computer application according to claim 9, wherein said interactive computer application being in said passive control discovery application mode after first detection of a person in said capture area of said sensoring part displays said person on a coupled display.
